(19) United States
(12) Patent Application Publication
(10) Pub. No.: US 2004/0175230 A1
(43) Pub. Date: Sep. 9, 2004

(54) Hanging connector

(76) Inventor: Wu-De Chang, Tai-Chung City (TW)

Correspondence Address: CHARLES E. BAXLEY, ESQUIRE, Fifth Floor, 59 John Street, New York, NY, 10038, US

(21) Appl. No.: 10/383,924

(22) Filed: Mar. 7, 2003

(51) Int. Cl. B25G 3/36

(52) U.S. Cl. 403/388

(57) ABSTRACT

The present invention discloses a hanging connector, comprising a connector body, and two grooves surrounding said connector and having a cylindrical supporting section at the center of said two grooves. Two fixed hanging points are defined between the connector and the fixed object and the hanging object, and such fixed hanging point varies according to the corresponding position or error situation of the hole position to compensate the error of distance between the holes of the fixed object and the hanging object. Even in the case of having an error in the hole position, the hanging object can still be successfully fixed onto the fixed object and maintain a relative secured position.

### BACKGROUND OF THE INVENTION

1. Field of the Invention

The present invention relates to a connecting member, more particularly to a connector for hanging an object onto a fixed object.

2. Description of the Related Art

There are many different ways of hanging an object onto a fixed object, and those closely related to this invention usually have at least two holes on each of the fixed object and the hanging object, so that the pairs of holes on the fixed object and the hanging object correspond to each other, and a connecting member passes through each corresponding hole and fixes the hanging object onto the fixed object. The best mode of connecting the fixed object and the hanging object relies on the complete correspondence of the diameter and distance of the holes, such that the connecting member can pass through the holes successfully. However, it is usually unable to keep the accuracy on setting and manufacturing the fixed object and the position of the hole, but generally causes errors in the hole position. Such error of the hole position will be disadvantageous to the general connection of the connecting members. Even such connecting members with erroneous hole position are connected, it may cause insecure hanging problem.

### SUMMARY OF THE INVENTION

The primary objective of the present invention is to provide a hanging connector having two fixed hanging points between the fixed object and the hanging object, and the fixed hanging point of the connector can be adjusted automatically according to the corresponding hole position or error situation to compensate the error of the distance between the holes of the fixed object and the hanging object. Even under the situation of having error in the hole position, the hanging object can be fixed onto the fixed object successfully, and maintain a relatively high stability.

To achieve the above objectives, the technical measure taken for the hanging connector according to this invention comprises:

a connector body; and

two grooves, surrounding said connector and having a cylindrical supporting section at the center of said two grooves.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective diagram of the connector according to the present invention.

FIG. 2 is a side-view diagram of the connector according to the present invention.

FIG. 3A is an illustrative diagram of the corresponding hole position between the fixed object and the hanging object according to the present invention.

FIG. 3B is an illustrative diagram of the connector coupling the hanging object with the fixed object according to the present invention.

FIG. 3C is a cross-section diagram of 3C-3C as shown in FIG. 3B.

FIG. 4A is another illustrative diagram of the corresponding hole position between the fixed object and the hanging object according to the present invention.

FIG. 4B is another illustrative diagram of the connector coupling the hanging object with the fixed object according to the present invention.

FIG. 5A is further another illustrative diagram of the corresponding hole position between the fixed object and the hanging object according to the present invention.

FIG. 5B is further another illustrative diagram of the connector coupling the hanging object with the fixed object according to the present invention.

FIG. 6A is an illustrative diagram of the connector being applied to a desk according to the present invention.

FIG. 6B is an illustrative diagram of the assembling the object as shown in FIG. 6A.

FIG. 7A is another illustrative diagram of the connector being applied to a desk according to the present invention.

FIG. 7B is an illustrative diagram of the assembling the object as shown in FIG. 7A.

### DETAILED DESCRIPTION OF THE PREFERRED EMBODIMENTS

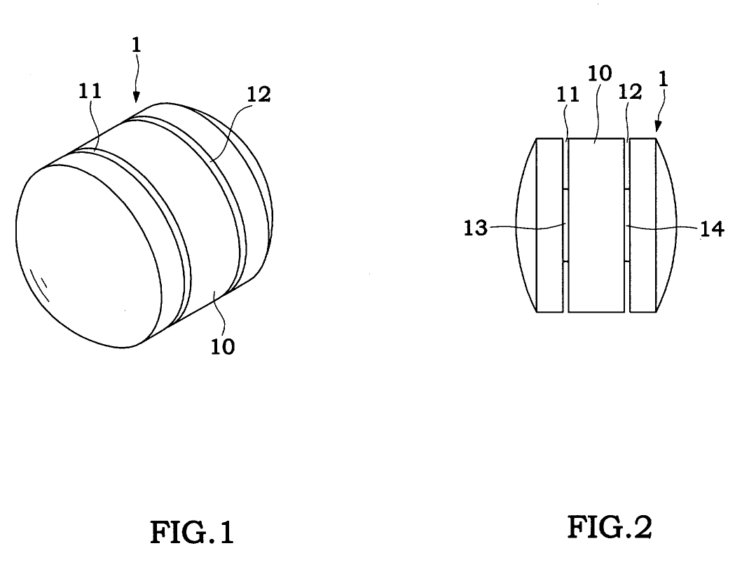

Please refer to FIGS. 1 and 2 for the connector structure according to this invention, and said connector comprises:

a cylindrical connector body 10, having two grooves 11, 12, and a cylindrical supporting section 13, 14 being formed on the same axle center of said two grooves 11, 12.

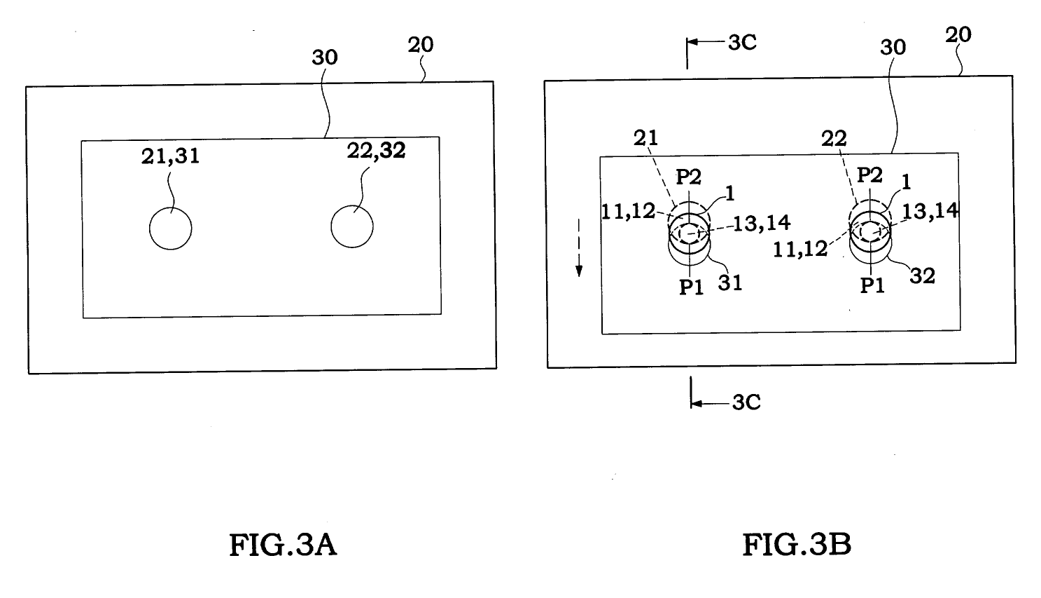

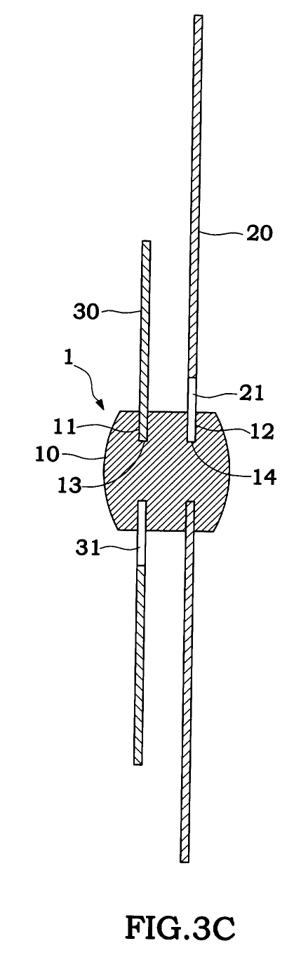

In FIGS. 3A to 3C, two hole positions are disposed around the connector body 10, and two hole positions are disposed on a hanging object 30. In the diagram of this embodiment, the hole positions 21, 22, 31, 32 on a fixed object 20 and the hanging object 30 are equidistant and have the same hole diameter, and the hole diameter is equal or larger than the overall external diameter of the cylindrical connector body 10. Both hole positions 21, 22, 31, 32 of the hanging object 30 and the fixed object 20 are corresponding to each other, and each corresponding hole position has a connector 1. One of the grooves 11 of the connector body 10 corresponds to the hole position 31, 32 of the hanging object 30, and another groove 12 corresponds to the hole position 21, 22 of the fixed object 20; at that time, the hanging object 30 moves downward by gravitational force such that the upper rim of the hole at the hole position 31, 32 of the hanging object 30 is embedded into the groove 11, and blocked by the upper edge of a supporting section 13. In the mean time, another groove 12 of the connector 1 also moves downward to be embedded into the lower rim of the hole position 21, 22 of the fixed object 20 and blocked at the lower rim of the hole of the fixed object by the lower upper edge of the supporting section 14. The upper and lower rims of the foregoing hole position intersected with the rim of the supporting section 13, 14 constitute the fixed hanging points P1, P2 of the fixed object 20 and hanging object 30 respectively. As in this embodiment, the fixed hanging point P1 is located along the 6 o'clock direction with respect to the hole position 21, 22 of the fixed object 20, and the fixed hanging point P2 is located along the 12 o'clock direction with respect to the hole position 31, 32 of the hanging object 30.

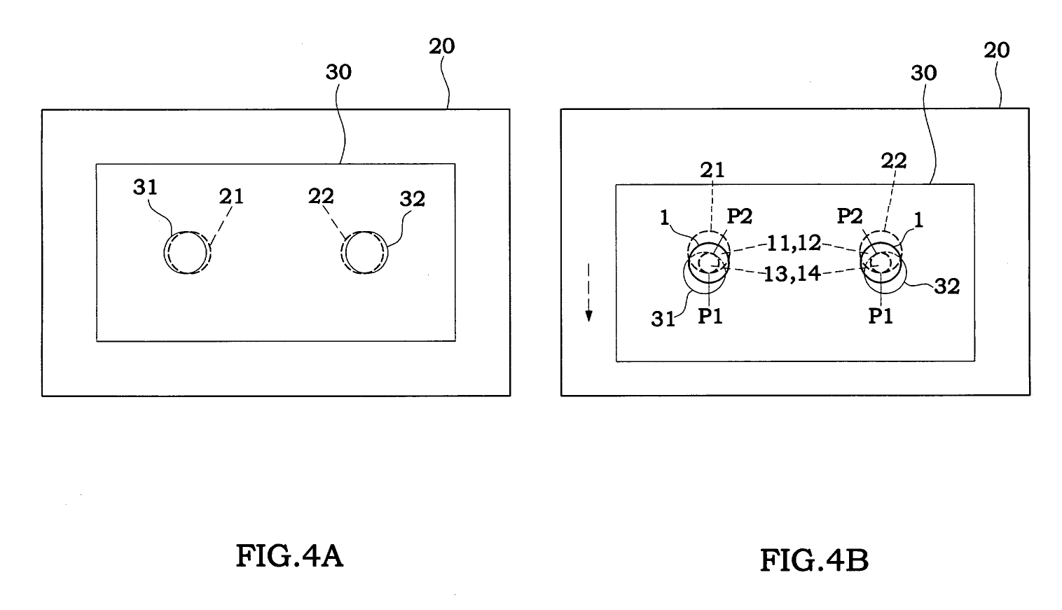

In FIGS. 4A to 4B, an embodiment shows that the hole distance of the fixed object 20 has an error smaller than the hole distance of hanging object 30. Same as the previous embodiment, when the connector 1 is set into the hole positions of the fixed object 20 and the hanging object 30, the fixed hanging point P1 is still located along the 12 o'clock direction with respect to the hole position 21, 22 of the fixed object due to gravitational force, but if the distance between two connectors 1 is smaller than the distance between the hole positions 31, 32 of the hanging object 30, the hanging object 30 will be embedded into the groove 11, 12 of the connector 1 with the hole edge at about 1 o'clock and 11 o'clock direction with respect to the hole position of the hanging object 30, and thus such connector has the effect of compensating the error of the hole position.

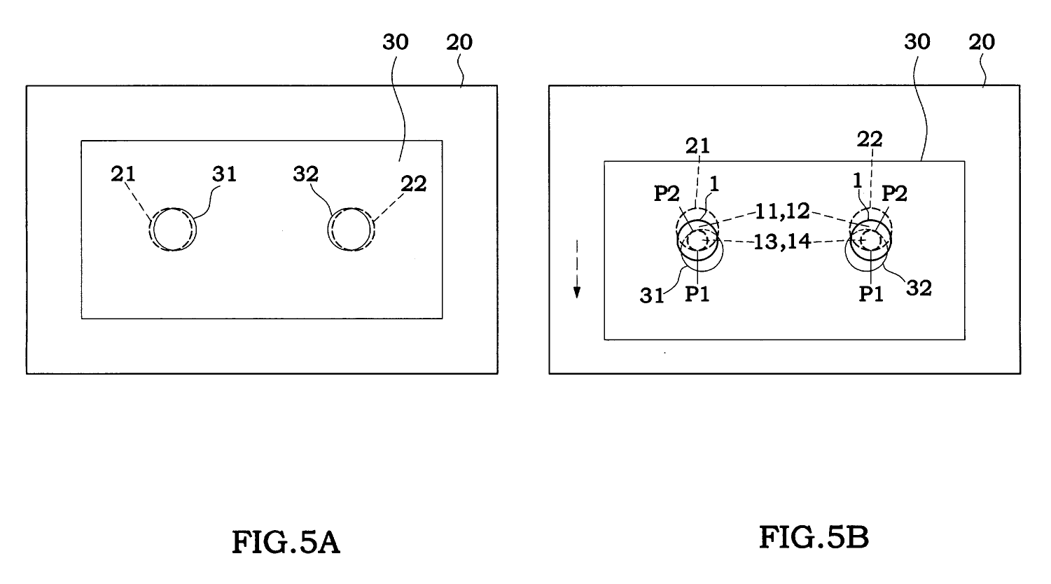

In FIGS. 5A and 5B, an embodiment shows that the hole distance of the fixed object 20 has an error larger than the hole distance of hanging object 30. Same as the previous embodiment, when the connector 1 is still located at the hole positions of the fixed object 20 and the hanging object 30, the fixed hanging point P1 is still located along the 6 o'clock direction with respect to the hole position 21, 22 of the fixed object due to gravitational force, but if the distance between two connectors 1 is larger than the distance between the hole positions 31, 32 of the hanging object 30, the hanging object 30 will be embedded into the groove 11, 12 of the connector 1 with the hole edge at about 11 o'clock and 1 o'clock direction with respect to the hole positions 31, 32 of the hanging object 30, and thus the fixed hanging points are also located along the 11 o'clock and 1 o'clock direction respectively to give the effect of compensating the error of the hole position.

The aforementioned fixed hanging points P1, P2 will vary according to the corresponding hole positions 21, 22, 31, 32 of the fixed object 20 and the hanging object 30, but such fixed hanging points are constantly the point of gravitational force for the hole rim of the hanging object acting on the supporting section 13 and the supporting section 13 acting on the hole rim of the fixed object 20. The connector 1 of this invention may automatically changes the fixed hanging point according to the corresponding situation of the hole position to compensate the error of distance between the holes of the fixed object 20 and the hanging object 30, such that the hanging object 30 can be successfully secured to the fixed object 20, and maintain a relatively secure position. Furthermore, the connector of this invention also has the advantages of simple and quick installation.

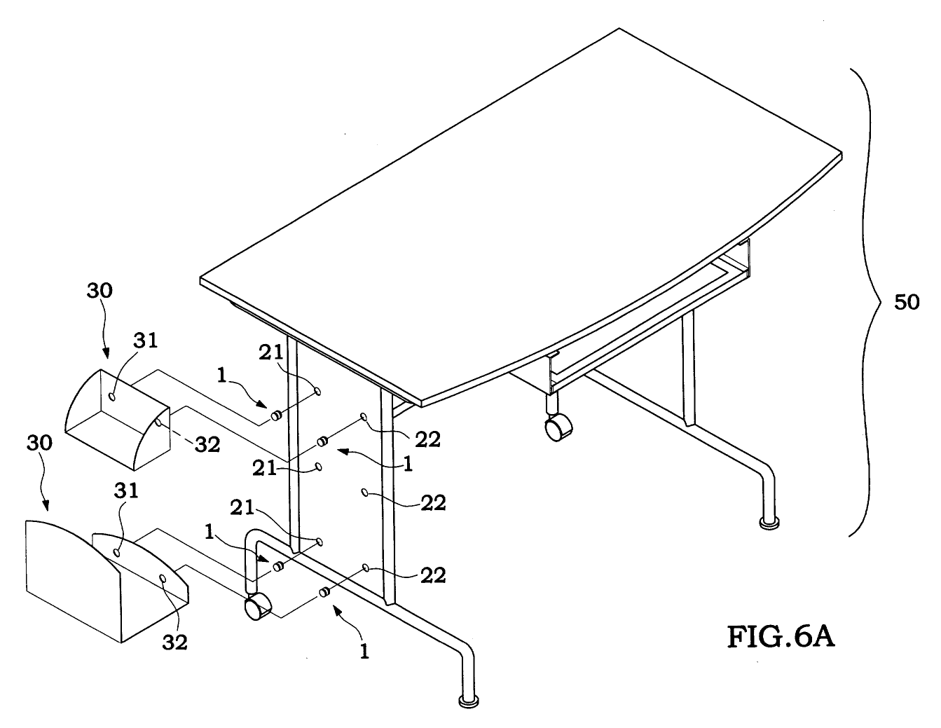

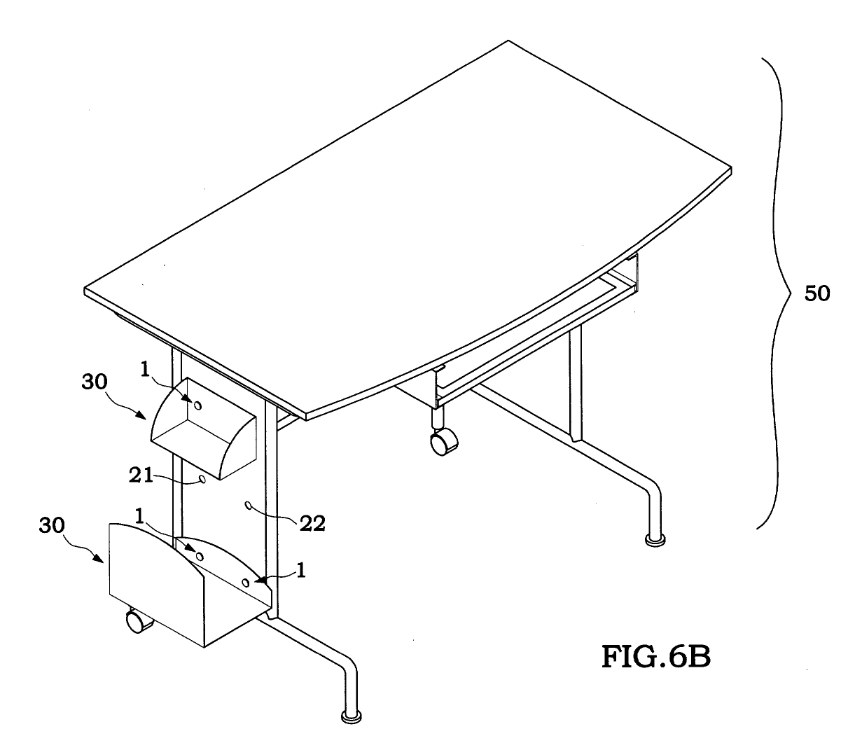

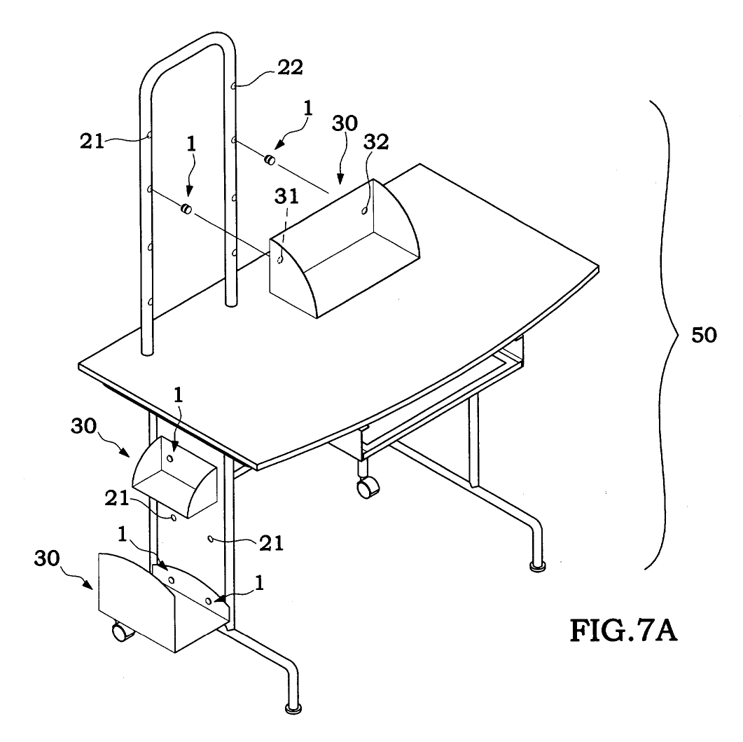

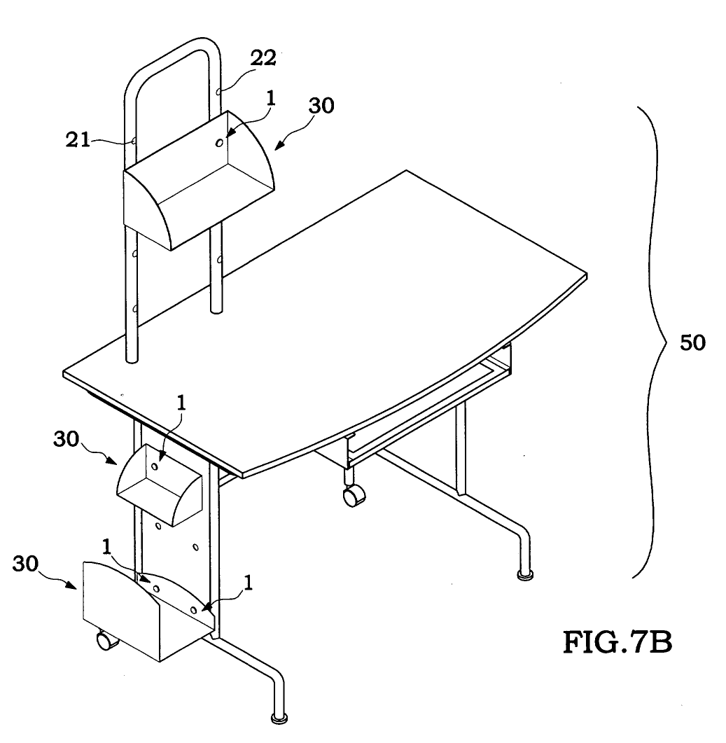

Refer to FIGS. 6A to 7B for the illustrative diagrams of an embodiment of this invention, which show a side of a desk 50, a plurality of fixed holes 21, 22 at the back of the desk 50; the hanging object 30 could be any kind of side rack, and a plurality of hole positions 31, 32 at the back of the side rack. The connector 1 passes through the foregoing hole positions 21, 22, 31, 32, so that the side rack is installed at a predetermined position of the desk.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

What is claimed is:

1. A hanging connector, comprising:
a connector body; and
two grooves, surrounding said connector body and having a cylindrical supporting section at the center of said two grooves.

2. The hanging connector of claim 1, wherein said connector body is substantially in cylindrical shape.

3. The hanging connector of claim 1, wherein said two supporting sections and said connector body have the same axle center.

4. The hanging connector of claim 1, wherein said fixed object and hanging object respectively have two hole position, each corresponding hole having one of said connectors, and the upper edge of the hole position of said hanging object being embedded into the groove and blocked at the upper rim of said supporting section; another groove of said connector being embedded into the low edge of the hole position of said fixed object and blocked at the lower rim of the hole of the fixed object by the lower rim of said supporting section.
